(19) United States
(12) Patent Application Publication
(10) Pub. No.: US 2004/0036679 A1
(43) Pub. Date: Feb. 26, 2004

(54) Computer system providing a visual indication when typing in caps lock mode

(76) Inventor: Harry E. Emerson, Succasunna, NJ (US)

Correspondence Address: HARRY E. EMERSON, 27 GARDEN COURT, SUCCASUNNA, NJ, 07876, US

(21) Appl. No.: 10/643,116

(22) Filed: Aug. 18, 2003

Related U.S. Application Data
(63) Continuation-in-part of application No. 10/427,591, filed on May 1, 2003.
(60) Provisional application No. 60/420,161, filed on Oct. 22, 2002.
(60) Provisional application No. 60/377,462, filed on May 2, 2002.

(51) Int. Cl. G09G 5/00

(52) U.S. Cl. 345/168

(57) ABSTRACT

Computer software providing a visual alert to the user when the keyboard is in the CAPS LOCK mode of operation by presenting either or both of a unique text insertion cursor or a unique mouse text pointer in place of the standard text insertion cursor or mouse text pointer.

This application is a continuation-in-part of U.S. patent application Ser. No. 10/427,591, filed May 1, 2003, which claims benefit of U.S. Provisional patent application No. 60/420161, filed Oct. 22, 2002, and which also claims the benefit of U.S. provisional patent application Serial No. 60/377,462, filed May 2, 2002.

### BACKGROUND OF THE INVENTION

1. Field Of The Invention

The present invention relates to computer keyboards, including the nature of keys provided on the keyboard, the layout of those keys, and the functionality provided by those keys in relation to the computer system.

2. Description Of The Prior Art

Computer keyboards have become standardized in their basic format for use with a variety of computers and computer operating systems. In particular, this document refers to computer keyboards compatible with computers designed according to Microsoft Corporation hardware specifications and the Intel Corporation microprocessor and system design (so called Wintel computers, an acronym referring to Microsoft Windows and Intel Corporation), and to keyboards compatible with computer operating systems capable of running on these computers, including the various Microsoft operating systems and varieties of the Unix operating system, especially Linux and its derivatives.

The following section describes the evolution of the computer keyboard from the introduction of the original IBM PC to today's current versions, and describes the function of the major keys and key groupings.

83-Key PC/XT Keyboard Layout

As illustrated in FIG. 1, the very first PC keyboard was the 83-key keyboard produced by IBM for the very first IBM PCs and PC/XTs in the early 1980s. This design was copied nearly verbatim by most of the early PC “clone” makers, and was the standard for PCs of this era. From a layout standpoint, however, there are numerous problems with the original 83-key layout, which caused many typists a great deal of frustration. Here are some of the main issues with this layout, when it is contrasted to more modern configurations:

Cramped Physical Grouping: It is a very “cramped” layout. All of the keys except the function keys are physically contiguous, giving the layout a very “busy” appearance. This is made worse by the fact that many keys are of odd sizes, and there is no clear vertical “dividing line” for the eye between the main typing area and the numeric keypad. Even the function keys are not separated very much from the rest of the layout. Overall, it looks like a “jumble of keys”. This may seem a trivial matter but has an impact on those learning to use the PC.

Poor <Shift> Key Size and Location: The <Shift> keys are rather small, and even worse, there is an extra key (backslash and vertical bar) between “Z” and the left <Shift> key, causing touch typists to accidentally hit this extra key when reaching for the left <Shift> key.

Poor <Enter> Key Size and Location: The <Enter> key is also rather small, and too far to the right, with an extra, rarely needed key (back-quote and tilde) between the main typing area and the <Enter> key. The <Enter> key doesn't line up vertically with the right <Shift> key.

Strange <Ctrl> Key Size and Position: Many users found the <Ctrl> key to be too large and in the place where they expected to find the <Caps Lock> key. In turn, the <Caps Lock> key is in an odd location.

No Dedicated Cursor and Navigation Keys: The only cursor and navigation keys are the ones on the numeric keypad. Since the cursor and navigation keys are needed almost all the time, this greatly reduced the utility of the numeric function of that keypad. (Remember that the most popular application in the early days of the PC was Lotus 1-2-3, a spreadsheet program used by financial people who needed both cursor movement keys and the numeric keypad.)

No Indicator LEDs: These early keyboards communicated unidirectionally with the system and could not accept the commands now used to control the indicator LEDs, so they included none. This caused much confusion, particularly given the frequency with which the <Num Lock> key needed to be pressed in order to flip between the cursor keys and the numeric keys. Some PC clone keyboards came out with indicator LEDs on them that were controlled by the keyboard itself to indicate the status of the <NumLock>, <CapsLock>, and <ScrollLock> keys. These mostly worked OK, but had the potential for becoming “out of sync” with what the system thought the state of the toggle modifier keys was.

Left-Side Function Keys: Many users disliked having the function keys on the left hand side of the keyboard, principally because early software would often provide visual cues on the bottom of the screen indicating what roles the different function keys would play in that application, and users wanted to see the function keys “line up” with these cues.

84-Key AT Keyboard Layout

IBM received a lot of complaints about the first keyboard design and eventually made improvements to it. The first evolution of the keyboard was the 84-key keyboard layout introduced with the first IBM PC/AT, illustrated in FIG. 2. (The LED indicators are above the numeric keypad and not shown in this photo.) This is sometimes called the AT Keyboard. There are several definite improvements with this layout, compared to the 83-key keyboard:

Better Physical Grouping: The keyboard has three distinct key physical groups, with the numeric keypad placed distinctly to the right. The three groupings have clean vertical lines. The numeric keypad has been reorganized. Overall, the keyboard has a much more organized and understandable appearance.

Improved <Shift> and <Enter> Keys: The left <Shift> key, and the <Enter> key, have been enlarged, and the seldom-used “intervening” keys relocated.

LED Indicators: With the new internals of this keyboard (see below), LED indicators for the “lock” functions were added. * Extra “System Request” Key: This is the “84th key”. It was mostly used for special control operations for PCs operating in communication with mainframe computer systems.

However, many of the layout issues with the original design remained. The biggest concern that remained unaddressed was the continued sharing between the numeric keypad, and the cursor and navigation keys. The function keys are still on the left-hand side, and the <Ctrl> and <Caps Lock> keys are still different from what a typist would expect.

This keyboard was changed internally from the PC/XT model as well. The interface was made bidirectional, allowing the system to send commands to the keyboard, and enabling the control of the new LED indicators. The signaling and interface protocols created with this first PC/AT keyboard are still used today, even though the 84-key layout is no longer used, having been replaced by the “Enhanced” 101-key keyboard.

101-Key “Enhanced” Keyboard Layout

In 1986, IBM introduced the IBM PC/AT Model 339. Included in this last AT-family system was the new Enhanced 101-key keyboard illustrated in FIG. 3. This 101-key keyboard would become the de-facto standard for keyboards through the current day. Even today's 104-key Windows keyboards and variants with extra buttons and keys are based on this layout. The “Enhanced” keyboard was electrically the same as the 84-key AT keyboard, but featured a radically redesigned key layout. The major changes included these:

Dedicated Cursor and Navigation Keys: Finally, separate keys were provided for cursor control and navigation. This enabled the numeric keyboard to be used along with the cursor and navigation keys. The cursor keys were also made into an “inverted-T” configuration for easier movement between the “Up” key and the “Down” key with a single finger.

Relocated Function Keys: The function keys were moved from the left-hand side of the keyboard to a row along the top, and divided into groups of four for convenience.

Extra Function Keys: Two additional function keys, <F11> and <F12> were added to the keyboard.

Relocated <Esc> and <Caps Lock> Keys: The <Esc> key was moved back to the left-hand side of the keyboard, and placed up above the main typing area. The <Caps Lock> key was moved above the left <Shift> key.

Extra <Ctrl> and <Alt> Keys: Additional <Ctrl> and <Alt> keys were added on the right side of the <Space Bar>.

Extra Numeric Keypad Keys: The numeric keypad was fitted with an additional <Enter> key, as well as the “/” (divide operator) that had been missing up to that point.

Compared with the 84-key keyboard the Enhanced keyboard layout was perceived by most users to be far superior. It was an immediate hit despite its one obvious inferiority to the AT keyboard due to the smaller main <Enter> key.

With these improvements, the 101-key keyboard layout became the standard, and was modified only slightly by the nearly identical 104-key Windows keyboard which is the standard now. Although the 101-key/104-key designs are the “standard”, some manufacturers have introduced variations of the basic design to make minor improvements. For example, a common modification is to enlarge the <Enter> key back to its “84-key layout size”, and squeeze the backslash/vertical-pipe key between the “=/+” key and the <Backspace>.

102-Key “Enhanced” Keyboard Layouts

Several slightly modified versions of the regular American English 101-key Enhanced keyboard were created by IBM for by non-English PC users. These keyboards are virtually identical to the regular 101-key Enhanced keyboards, incorporating just slight differences from the regular U.S. keyboard. Considering the United Kingdom layout as an example, the following changes have been made:

The regular number “3” key now yields “£” instead of “#” when shifted.

The back-quote key yields the “-” (horizontal bar) symbol when shifted instead of a tilde (“˜”).

The main <Enter> key has been enlarged; it is now L-shaped again (though upside-down}

An extra key (the 102^{nd}) containing the supplanted “#” and “˜” symbols has been added to the left of the main <Enter> key. (This seems a step backwards given the complaints about an extra key in this location in the 83-key layout.)

Another step backwards: the backslash/vertical bar key has been relocated back to its former place—to the right of the left <Shift> key.

104-Key “Windows” Keyboard Layout

As Windows became the predominant operating system in the PC market, Microsoft realized that many common Windows functions had no simple keyboard shortcuts to activating them. Seizing their leadership position, they created a specification for a new variant of the 101-key keyboard that includes special keys to activate common Windows functions. This design is the 104-key “Windows” keyboard, illustrated in FIG. 4.

This layout is identical to the 101-key Enhanced layout with the exception of the additional three keys: one Windows key on either side of the <Space Bar>, and a Windows context menu (right-click) key to the right of the <Space Bar>. This layout makes room for them by stealing real estate from the <Alt>, <Ctrl> and <Space Bar> keys along the bottom of the keyboard. In addition to the new Windows keys, the particular keyboard model shown in the illustration of FIG. 4 incorporates the larger main <Enter> key, enabled by moving the backslash/vertical pipe key up one row, placed next to the now-smaller backspace key. Although the particular model as shown incorporates this <Enter> key modification, the majority of Windows keyboards on the market incorporate the <Enter> key layout of the 101-key Enhanced keyboard. The functions of the two types of Windows keys are as follows:

“Windows” Keys: Two keys, one to the left of the <Space Bar> and one to the right, are used to activate various functions within the operating system. If either is pressed by itself, it puts the Windows task bar in the foreground and opens the Windows start menu. (Note that this is identical to the function performed by the key combination <Ctrl>+<Esc>). The Windows keys are also like modification keys, as they enable several “short cut” actions through special key combinations such as opening the Windows Explorer by simultaneously pressing a Windows key and the <E> key.

Context Menu Key: This key, on the right-hand side of the keyboard, is used to simulate right-clicking the mouse at its current location. Under standard Windows functionality, this opens up a context menu of commands relevant to the Window or object the mouse was over at the time the key was pressed.

Since the Windows keyboard offers some flexibility that the regular Enhanced layout does not, and its cost of production is virtually unchanged, it quickly replaced the Enhanced layout as the de-facto standard on most PCs. Most keyboards today, whether they are included with new PCs or sold separately, are some variation of the 104-key Windows keyboard layout.

Modern 104-key Windows Keyboards with Special Purpose Keys

Many specialty keyboards have extra keys or buttons, above and beyond the keys normally found on “standard” keyboards. These are becoming increasingly popular as companies look to provide convenience features on the keyboard, and possibly differentiate their offerings from those of competitors. Keyboards dubbed “Internet keyboards” or “multimedia keyboards” usually have at least some of these extras.

These special keys are usually provided in addition to the regular 104 keys of a standard Windows keyboard, squeezed in along the top of the keyboard or on the right-hand or left-hand side. They of course differ by keyboard type, however, they commonly fall into the following categories.

Internet Shortcuts: A series of buttons to implement common Internet functions, such as connecting to the net, or opening a web browser or email software.

Audio Controls: Buttons that let you raise or lower your PC's sound volume, mute the sound, and so on. Some also include buttons that implement standard CD player functions: start/stop, pause, next, previous and such. Some include a rotary volume control.

Mouse Controls: Buttons that simulate movement of the mouse, or mouse clicks.

An example of a 104-key Windows keyboard with additional special purpose keys is illustrated in FIG. 5. This Hewlett-Packard keyboard is just packed with extra buttons and features. These include numerous Internet buttons, audio controls, CD player controls, and a rotary volume control (visible in the upper right hand corner).

Programmable keyboards which allow the user to define the role of individual keys also typically have extra keys, which are used to enable programming modes. Also, some foreign-language keyboards have additional keys corresponding to special characters required for those languages.

Since “extra” keys are non-standard and differ for each keyboard, special drivers or software are required to enable the special functions. Otherwise, the operating system won't know what to do with the unexpected, non-standard scan codes, and will probably just ignore them. More popular keyboards may have support built into Windows, and some foreign-language keyboards may also have native support. Otherwise you will need driver software from the maker of the keyboard.

Description of the Major Types of Keys

This section describes the purpose and operation of the major types of keys found on the 101-key and 104-key standard keyboards. The primary typographic keys include the following:

Alphabetic Keys: The keys A through Z. Regular keypresses produce lower-case letters, and shifted keypresses create upper-case letters. <Caps Lock> reverses the <Shift> key functionality.

Numeric/Punctuation Keys: These are the numeric keys along the top of the keyboard, above the alphabetic keys. Shifted, they produce various punctuation and special symbols. The numerics are pretty much universal on English-language keyboards; the punctuation symbols can be different depending on region. For example, the “#” key in the United States is a “£” symbol in the United Kingdom.

Other Main Punctuation Keys: Most of the other punctuation keys on the keyboard are located just to the right of the alphanumeric keys mentioned above. While they have special meaning in some software applications, they are “just characters” most of the time.

“White Space” Keys: These include the primary (main) <Enter> key, the <Tab> key and the <Space Bar>. These keys are used for formatting text, and to delimit text entries and commands. Collectively they are often referred to as “white space” since they are characters that separate “real” characters without containing any information in and of themselves. There is also a secondary <Enter> key that is part of the numeric keypad.

<Delete> and <Backspace> Editing Keys: In text-based applications—or in text fields within other applications (for example, a Web browser)—these keys are usually used in conjunction to allow deleting of characters. The standard followed in most software is that the <Delete> key removes a character to the right of the insertion point, and the <Backspace> key removes a character to the left of the insertion point. In other contexts such as word processors and email programs, the <Delete> key may be used to delete or remove any type of object; in these applications, regions of text and objects may be selected, for example, by using the techniques described for the <Shift> key, and then deleted by pressing the <Delete> key.

One of the most important advances of the new 101-key “Enhanced” keyboard created by IBM was the creation of separate, dedicated cursor-control and navigation keys. These had formerly been accessible only by using the numeric keypad. On modern keyboards these important keys are generally placed between the numeric keypad and the main typing area. The cursor control and navigation keys are also still also available using the numeric keypad, of course, but this is rarely used today. This set of keys includes the following:

Arrow Keys: These keys permit motion in most software programs in any of the four standard directions that exist in two dimensions: up (north), down (south), left (west) and right (east). In many programs these perform functions similar to those that a mouse does, simulating two-dimensional movement. Some keyboards 15 actually have eight arrow keys; the additional four keys are diagonals that correspond to the “northwest”, “northeast”, “southwest” and “southeast” directions. The default arrangement is an “inverted-T” configuration. Some keyboards may use instead a “diamond pattern”, with the up arrow key higher.

<Page Up> and <Page Down>: These keys (sometimes labeled “PgUp” and “PgDn”) are used in software programs primarily for one-dimensional scrolling, for example, to go up or down one page in a spreadsheet program, word-processing document, Web page and so on.

<Home> and <End>: The <Home> key is usually used to go to the left side of the current line in a document, and the <End> key to the right side. The current line is the line of text having the active cursor, meaning the location on screen where the next keyboard action will take place.

The keyboard contains several keys that serve primarily to alter the function or meaning of other keys. They are often used in combination with another key (typically by holding them down and then pressing the other key) or are typically used to set a particular keyboard state. These will be referred to as modification keys, grouped into two different sub-categories. The first are temporary modification keys, because they modify other keys only while held down. This includes:

<Shift> Keys: These two keys are near the bottom of the keyboard, one on either side of the main typing area. They enable access to capital letters, and also to the “alternate” functions printed on the keycaps above the unshifted symbol or function shown. So for example, holding the <Shift> key down and pressing the equal sign (“=”) generates a plus sign (“+”). The <Shift> keys also change the behavior of the function keys in most software programs; for example, <Shift>+<F6> is different than just <F6>. The <Shift> key functions within Windows applications to create a selected region of text or objects (or both) when used in conjunction with the navigation keys; holding the <Shift> key down while simultaneously pressing an arrow key, the <Home>, <End>, <Pageup>, or <PageDown> keys will create a selected region. A selected region can be deleted with the <Delete> key, or can be moved, copied or have other actions performed on it according to the capabilities of the software application being used.

<Ctrl> Keys: These are the “control keys”; one is located on either side of the typing area. Sometimes the keycap says “Control” instead of the shortened “Ctrl”. These keys are used in combination with regular alphanumeric keys and also the function keys to control special features and functions in software programs.

<Alt> Keys: These are the “alternate control keys”. They operate the same way the <Ctrl> keys do; their presence just lets complex software have more options. For example, <Alt>+<F6> can be a different function than <Ctrl>+<F6>. The <Alt> keys are also used for ASCII code generation.

<Insert>: In modern computing systems this key functions as a toggle key to switch between the normal “insert mode”, where all typed characters are automatically inserted, and “replace mode”, where typed characters replace those at the text insertion point. Historically it was used to insert a space in a text area each time it is pressed, but that usage is now rare.

The temporary modification keys can be combined if held down. For example, holding down <Shift>+<Ctrl>+the up arrow in the Microsoft Word application will select the entire current paragraph.

The second sub-category contains locking modification keys. These are toggle keys—they change the function of other keys until they are pressed again to cancel the effect:

Caps Lock: When pressed, causes the function of the <Shift> keys to be reversed, but only for letter characters; other keys are unaffected. When active, the Caps Lock LED will be lit.

Num Lock: Enables the numbers on the numeric keypad when activated, and lights the Num Lock LED as well. When not active, the numeric keypad's keys generate cursor-control functions instead. This functionality dates back to the earliest PCs, which did not have dedicated cursor-control keys; today the cursor-control functions on the numeric keypad are redundant, which is why many people leave Num Lock always enabled.

Scroll Lock: Lights the Scroll Lock LED and causes some software programs to alter their behavior when certain other keys are pressed. In particular, when Scroll Lock is active, the cursor keys are often used to scroll the visible document rather than change position within it. This is not used nearly as much as the other two.

Lastly, the 101-key and 104-key keyboards include some miscellaneous keys not easily categorized; they are:

Function Keys: The function keys are a set of twelve numbered keys that are used by different software programs for a variety of different purposes. They are sometimes called programmable function keys or just F-keys or PF-keys. The original PC keyboard designs had 10 function keys, arranged in a 2×5 matrix on the left-hand side of the keyboard. With the introduction of the 101-key Enhanced keyboard, this was expanded to 12 keys, which were moved to a single row along the top of the keyboard. The exact duty of the function keys depends entirely on how the software chooses to interpret them.

<Escape>: The Escape key is usually used as an “exit” key of sorts by programs, to cancel commands or get out of something. It is also used in some contexts to change the meaning of subsequent characters.

<Print Screen/Sys Rq>: When pressed from DOS, this key causes the contents of the current screen of text to be sent to an attached printer. From within Windows, it copies the contents of the screen, in graphical format, to the Windows clipboard. The alternate use of this key is for the “system request” function. This is a historical command originally based on older IBM terminal designs, and is not really used any more.

<Pause/Break>: When pressed by itself, pauses the display or operation of some software programs. When pressed in combination with the <Ctrl> key, sends a “break” command that will interrupt some software programs or DOS commands. (You can do the same thing with <Ctrl>+C).

Key Groupings

The 101-key and 104-key keyboards are divided into seven major key groupings. Referring to FIG. 3, they are: a) the main alphanumeric (typewriter) section 20; b) the numeric cluster 22; c) the function keys 24; d) the Escape key 26; e) the arrow cluster 28; f) the miscellaneous key group 30 comprising <PrintScreen>, <ScrollLock>, and <Pause>; and g) the navigation key group 32 comprising <Insert>, <Delete>, <Home>, <End>, <PageUp>, and <PageDown>.

Prior Art Deficiency and Opportunity for Improvement

As reported in the preceding narrative, there has been development and advancement in the design, functionality, and usability of the computer keyboard over the last two decades, driven primarily by deficiencies and difficulties experienced by the user community. However, not all needs and opportunities for improvement have been entirely obvious to previous developers, and the pretext of this patent application is that there remains room for improvement.

In particular, touch typists frequently experience the problem of typing characters into a document in all capital letters (Caps) because the CAPS LOCK key has remained on from the previous typing occasion. Even though there is a keyboard light to alert the user to the fact that the keyboard is in the CAPS LOCK mode, touch typists may seldom look at the keyboard, and even if they do, the CAPS LOCK light is easy to overlook. Instead of looking at the screen of keyboard, touch typists commonly look at the source materials they are using to create the on-screen document. If the CAPS LOCK key happens to be on (and consequently the keyboard is in the CAPS LOCK mode) when the user starts typing, the new text will all be entered in capital letters. The next time the user glances at the screen they will notice the error and will need to take steps to correct it. Even though there might be simple ways to make such a correction, creating the typing error and having to correct it is an annoyance, and an improvement to minimize or eliminate this annoyance would be desirable.

Because of the deficiency of the current keyboard design, there remains a need in the art for a computer system design or application software design having a means to alert the typist when the keyboard is in CAPS LOCK mode.

### SUMMARY OF THE INVENTION

The present invention provides a simple means for computer users to be alerted to the fact that the computer keyboard is in CAPS LOCK mode, that is to say that the CAPS LOCK key is activated and alphanumeric characters that are typed will appear on-screen in capital letters. There are two embodiments to the CAPS LOCK alert; these two embodiments are not mutually exclusive, and both could be implemented into the same computer and computer keyboard system.

In the first embodiment, an audible alert is provided to the typist when they begin to type while the keyboard is in CAPS LOCK mode. The audible alert is optionally provided by the “keyboard bell” mechanism, although other implementations are possible as well. In the era of Teletype machines, keyboards actually had a bell which would ring upon the sending or receipt of an appropriate signal (which actually is the ASCII bell character, character 07 in the ASCII table). (Note: ASCII is the American Standard Code for Information Interchange. The lower 128 characters are identical in the ASCII and ANSI standards. In common industry terminology, the ASCII standard is usually mentioned in reference to a specific character and character number, but it would be equally accurate to refer to the ANSI bell character 07 in the ANSI table.) The keyboard bell mechanism still exists in modern Personal Computers since every computer keyboard is capable of generating all of the lower 128 characters, including the bell character. Typing “Control-g” (or “Control-G”) generates the bell character. The modem computer, rather than having a bell in the keyboard, would use the system speakers to produce an equivalent audible sound. Therefore, one possible implementation of this embodiment is to have the keyboard generate a bell character as the alerting signal. Additionally, there are many possible methods for having a keyboard generate a software signal or message to which the computer system will respond by creating an audible sound, and any such method would constitute a satisfactory implementation of this embodiment of the current invention. Furthermore, the logic that generates such a software signal or message need not come from the keyboard, but could originate from any hardware or software component in the system which is involved in processing keyboard data. Therefore, in an alternative implementation of this embodiment of the current invention, either the computer's hardware, operating software, keyboard driver software component, or an application software is arranged to generate an audible signal to indicate that the CAPS LOCK mode is active when a user begins to type.

In the preferred embodiment the keyboard is provided with a USB interface to the computer system. USB interfaces are message oriented and convey messages of a wide variety to the computer operating software, drivers, or applications. Logic within the keyboard determines if typing has begun while the keyboard is in the CAPS LOCK mode, and if so sends an appropriate message to a keyboard driver software. The keyboard driver software responds by generating an audible signal through the computer's speakers.

There is one computer accessory vendor having a software application that provides a similarly intended service to the alert provided by the current invention. In that vendor's product the user can select to have the system generate an audible click whenever the CAPS LOCK key is turned on or off. That arrangement, however, provides no useful function since the typist knows when they are pressing the CAPS LOCK key. It does not alert the user to the fact that the CAPS LOCK key has already been activated when they start typing.

In yet another embodiment of this invention, the CAPS LOCK mode is associated with a software timer, preferably adjustable by the user. While in the CAPS LOCK mode, the timer starts or restarts every time a key is struck. A reasonable period of time for such a timer would be five or ten seconds. If the duration of time specified by the timer passes with no key strokes, the timer expires and the CAPS LOCK mode is turned off. Optionally, the CAPS LOCK mode LED might blink momentarily when the CAPS LOCK mode is turned off, as an announcement to the user.

In another embodiment of this invention the user is given a visual indication that the keyboard is in CAPS LOCK mode by presenting a unique symbol instead of the standard symbol for either or both of the text insertion cursor and the mouse text pointer.

In the standard software implementation of word processors, email editors, and similar programs, a text insertion cursor, typically presented as a vertical line or bar, is used to indicate the location on-screen where the next typed character will appear. The text insertion cursor advances as characters are typed, and is moved by the keyboard arrow keys, home and end keys, and page-up/page-down keys. On input screens with data entry fields, the Tab key advances the text insertion cursor from one text field to the next. Typists frequently use the mouse or cursor arrows to position the text insertion cursor before beginning to type, and so a visual cue utilizing the text insertion cursor would be helpful to indicate the state of the CAPS LOCK key. In the present invention, the text insertion cursor is changed to have an identifying characteristic when the CAPS LOCK key is turned on, serving to alert the user to that fact. An identifying characteristic might include a unique shape or color, a distinctive blink rate, and so on.

In still another embodiment of this invention, the CAPS LOCK mode is associated with a unique Mouse Cursor, also commonly referred to as a Mouse Pointer. There are approximately a dozen cursor shapes incorporated into the Microsoft Windows operating systems and the Apple Computer Inc. operating systems. Cursor shapes that users commonly encounter include a northwest arrow as a general purpose pointer, an hourglass suggesting that we wait a bit, and an I-beam used to mark the location where text will be entered. In a typical Microsoft Windows environment, the available cursors can be viewed at C:/WINDOWS/CURSORS.

This aspect of the present invention relates to the I-beam cursor, which, to add a bit of confusion, is referred to as a text cursor in the context of browsers. This document has previously referenced a “text insertion cursor”, the vertical bar that identifies the location where the next character will be typed, so for clarity the text cursor that serves as a mouse pointer will be referred to herein as a mouse text pointer. The mouse text pointer moves around the screen as you move the mouse, and sets the location for the text insertion cursor. The present invention provides for the presentation of a unique shape of either or both the text insertion cursor and the mouse text pointer when the CAPS LOCK key is on.

There is always a mouse pointer associated with the computer display screen in terms of x-y coordinates. Even though under some circumstances the mouse pointer may be hidden, the mouse pointer always has an x-y coordinate associated with it, and thus always points to somewhere on the screen, and identifies the location at which position-related mouse events will occur upon clicking the mouse button. For example, a user activates a button, menu, or hyperlink by bringing the mouse pointer over the desired item and then clicking the mouse button. Software controls provide the ability for software designers to select the type of mouse pointer that should appear when the mouse pointer is within the x-y boundaries (referred to as mouse over) of various types of screen objects such as menus, buttons, drawing objects, and so on (for example, the mouse pointer changes to a hand symbol when over a hyperlink); the selection is made from one of the available cursor shapes. Conveniently, the Microsoft and Apple operating systems (and perhaps others) also allow for the creation and use of custom cursor shapes.

The mouse text pointer is active within text object regions. From a programming perspective, text objects are screen areas that will accept user text input. Usually the text input comes from the keyboard, but it could come from other sources such as user speech in which a voice recognition program translates spoken user words into text. And normally the contents of the text object are displayed on the screen, but not so under some circumstances such as inputting a password. While being aware of these exceptions, this document for convenience will discuss matters as if all user input comes from the keyboard and is displayed on the screen.

All computer systems with a Graphical User Interface have adopted a standard implementation of the mouse text pointer. The mouse text pointer (normally the I-beam) allows the user to click on a location within the text object at which they wish their typed input to appear. When the user clicks on a permissible screen location within the text object, the system sets the “text insertion cursor”—the vertical bar—at that location. The vertical bar normally blinks at a rate of about once a second and serves as an indication to the user of where their words will appear. Once a user starts typing, the mouse text pointer I-beam normally disappears since it is unnecessary to be displayed during user keyboard input since the text insertion cursor is the user's focal point. But, if the user moves the mouse, the mouse text pointer reappears; the user can then reposition the mouse text pointer to set a new location for the text insertion cursor and begin typing at another screen location.

USERS COMMONLY MAKE THE MISTAKE OF TYPING ACCIDENTALLY IN ALL CAPS BECAUSE they were typing a text entry that required all caps, and then the text topic changed. Perhaps they were typing a title or header or some other kind of text entry that demanded all capital letters, so the user hit the CAPS LOCK key and then typed their data. Moving on to the next text topic might require the user to direct their attention off-screen, perhaps to a document, and very commonly causes the user to move the text insertion cursor to another location on the screen with the mouse. During this interval the user might forget that the CAPS LOCK key is still on, and so when they start typing again, the text inadvertently appears in all caps.

The present invention aids the user by presenting them with a unique mouse text pointer when in CAPS LOCK mode. Thus, if a user uses the mouse to move from one text entry location to another, their eyes are fixed on the mouse text pointer; the shape of the unique mouse text pointer is an indication that the CAPS LOCK key is on, and because the user is looking squarely at the mouse text pointer, they can't help but realize that the CAPS LOCK key remains on. It will then be a natural reflex to retire the CAPS LOCK key before continuing, and thus users will be spared from the annoyance of mistakenly typing in all capital letters.

This invention, then, provides means to indicate to the user when the CAPS LOCK key is on by presenting them with a unique image for either or both of the text insertion cursor and mouse text pointer.

### BRIEF DESCRIPTION OF THE DRAWINGS

The invention will be more fully understood when reference is had to the following detailed description of the preferred embodiment of the invention and the accompanying drawings, in which:

FIG. 1 is an illustration of the 83-key original IBM PC keyboard;

FIG. 2 is an illustration of the 84-key IBM PC/AT keyboard;

FIG. 3 is an illustration of the 101-key Enhanced IBM keyboard;

FIG. 4 is an illustration of the 104-key “Windows” keyboard;

FIG. 5 is an illustration of a contemporary “multimedia” keyboard;

FIG. 6 is a flow chart of the audible alert logic;

FIG. 7 is an illustration of an implementation of a CAPS LOCK alerting insertion cursor;

FIG. 8 is an illustration of a portion of text incorporating the insertion cursor of FIG. 7;

FIG. 9 is a flow chart of the CAPS LOCK timeout logic; and

FIG. 10 illustrates a conventional I-beam mouse text pointer, and two variations of a CAPS LOCK mouse text pointer.

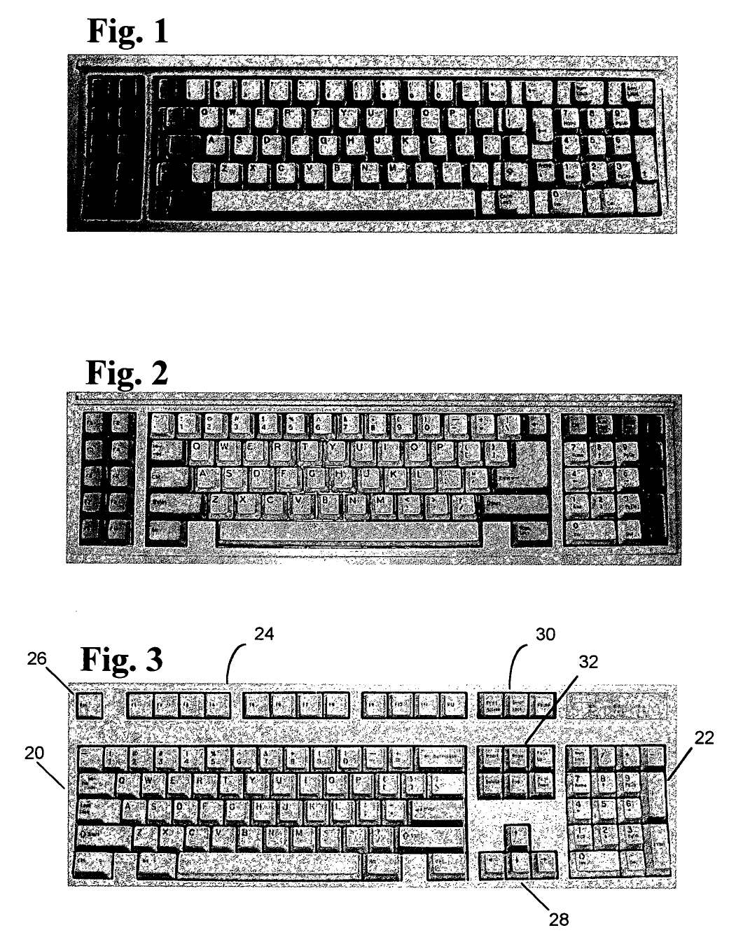

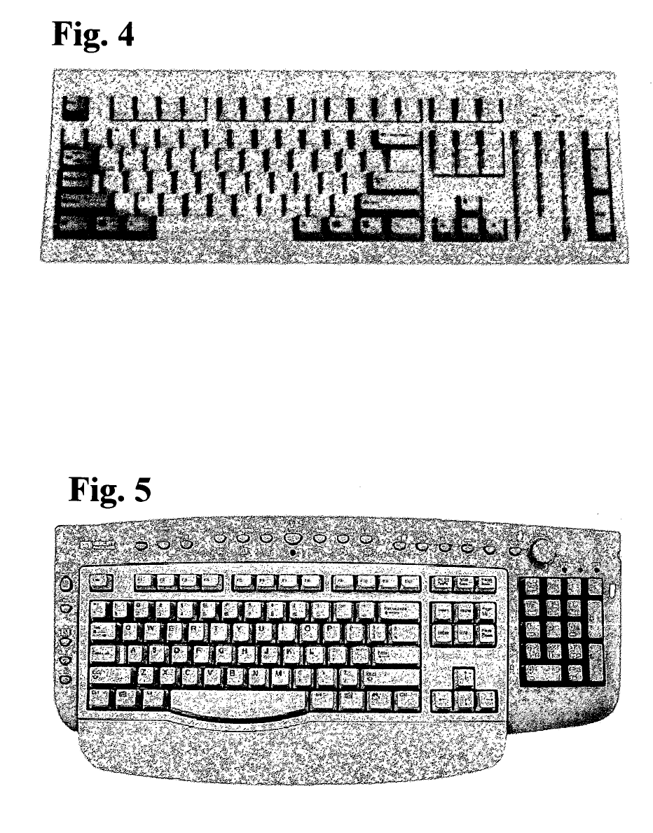

### DETAILED DESCRIPTION OF THE INVENTION

The present invention provides a simple means for computer users to be alerted to the fact that the computer keyboard is in CAPS LOCK mode, that is to say that the CAPS LOCK key is activated and alphanumeric characters that are typed will appear on-screen in capital letters. There are two aspects to the CAPS LOCK alert invention; these two aspects are not mutually exclusive, and both could be implemented into the same computer and computer keyboard system.

In the audible alert aspect of the current invention, an audible alert is provided to the typist when they begin to type while the keyboard is in CAPS LOCK mode. The location of the logic which determines that the user has begun typing while the keyboard is in CAPS LOCK mode is arbitrary. It could optionally reside in the keyboard, in the computer's operating software, in a software keyboard driver, or in some similar hardware or software component of the computer system. In the preferred embodiment of the audible alert aspect of the current invention, this logic is contained in the keyboard which communicates an appropriate message via a USB (Universal Serial Bus) connection to a keyboard driver software component running on the computer system. The keyboard driver then generates an audible signal.

The general rules of the CAPS LOCK alerting logic are as follows: If the CAPS LOCK key is pressed and the user begins to type alphabetic characters promptly, do not alert them to the CAPS LOCK mode; If the CAPS LOCK key has been on for a while after the last alphabetic key has been typed, long enough that the user may have forgotten that the keyboard is in the CAPS LOCK mode, sound an alert when the next alphabetic key is typed. Optionally the alert may also sound when the CAPS LOCK key is activated.

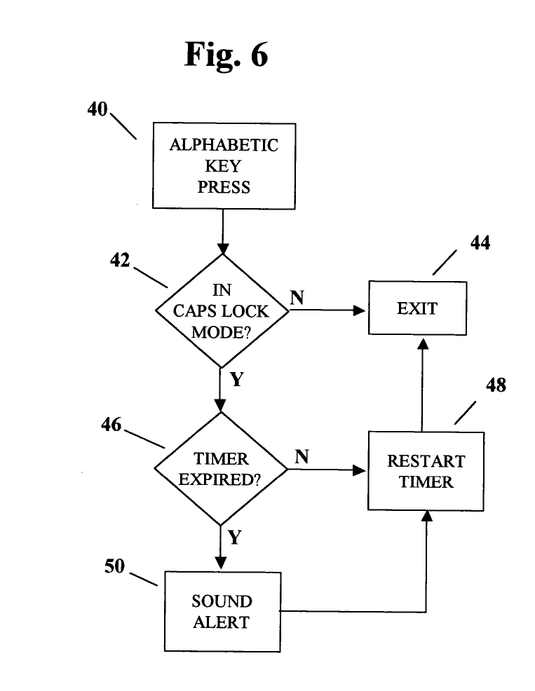

In order to accomplish the above general rules, the CAPS LOCK alerting logic incorporates a timer of an arbitrary period such as ten seconds. The logic functions as described in the flow chart of FIG. 6: At step 40 the system determines that an alphabetic key press has taken place. At step 42, if the keyboard is not in CAPS LOCK mode the logic stream exits to step 44, but if the keyboard is in CAPS LOCK mode the timer is examined in step 46. If the timer has not expired then the alert will not be sounded; instead the timer is restarted at step 48, and the logic system exited at step 44. If the timer has expired at step 46 then the system moves to step 50 to sound the alert, then restarts the timer at step 48, and finally exits at step 44.

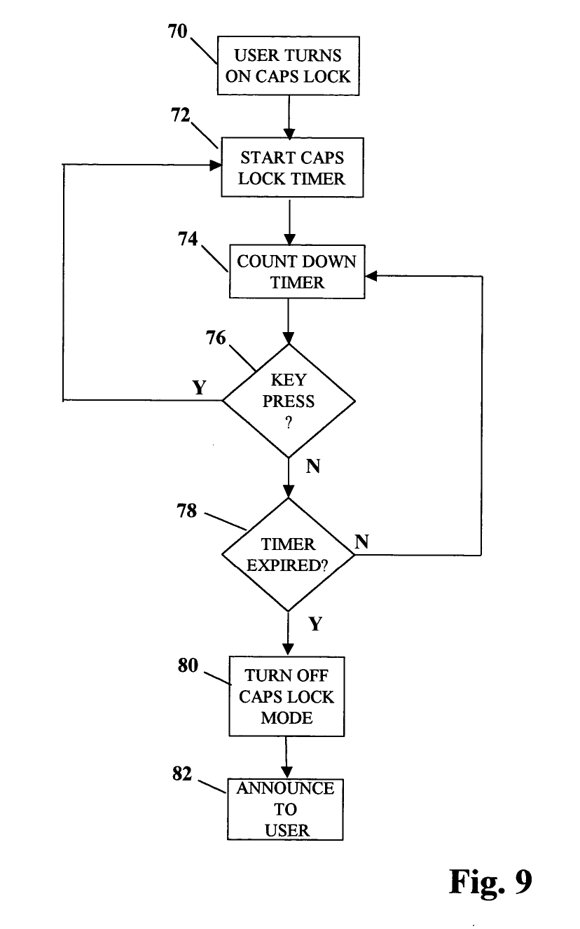

FIG. 9 is a flowchart that illustrates another aspect of this invention associated with a CAPS LOCK mode timer, implemented in keyboard or system software or similar logic. While in the CAPS LOCK mode, the timer starts or restarts every time a key is struck. The timer will expire after a specified period in which no keys are struck. A reasonable period of time for such a timer would be five or ten seconds. Upon expiration of the timer, the CAPS LOCK mode is turned off. The timer duration may be adjustable by the user, and the feature may be activated or inactivated by the user. Optionally, an announcement may be provided to the user when the CAPS LOCK mode is turned off, such as by blinking the CAPS LOCK mode LED momentarily, sounding an audible indicator, or providing a brief visual indicator on the user's display screen.

In terms of general operation, the user turns on the CAPS LOCK key and types whatever they wish in capital letters. The timer is perhaps set to default to five seconds. Every time the user strikes a key while the timer is still active, the five-second timer restarts. When five seconds has transpired with no keystrokes, the system turns off the CAPS LOCK mode, and optionally provides an indication to the user of that event.

Referring to FIG. 9, the process starts at process block 70 when the user presses the CAPS LOCK key to enter the CAPS LOCK MODE, causing a CAPS LOCK timer to start at block 72. Presuming that this is a countdown timer, the timer counts down at regular intervals at block 74. If a key press has occurred at block 76 before the timer has expired, the timer logic reverts to process block 72 and restarts the timer. If no key press has occurred and the timer has not yet expired at block 78, the system reverts to block 74 and continues to count down. If, however, the timer has expired, the process flows to block 80 and turns off the CAPS LOCK mode. Optionally, an indication that the CAPS LOCK mode has been terminated is provided to the user at process block 82.

In another aspect of this invention the user is given a visual indication that the keyboard is in CAPS LOCK mode. In the standard software implementation of word processors, email editors, and similar programs, a text insertion cursor, typically presented as a vertical line, is used to indicate the location on-screen where the next typed character will appear. In this aspect of the current invention, the text insertion cursor has an identifying characteristic when the CAPS LOCK key is turned on, serving to alert the user to that fact. An identifying characteristic might include a unique shape or color, a distinctive blink rate, and so on.

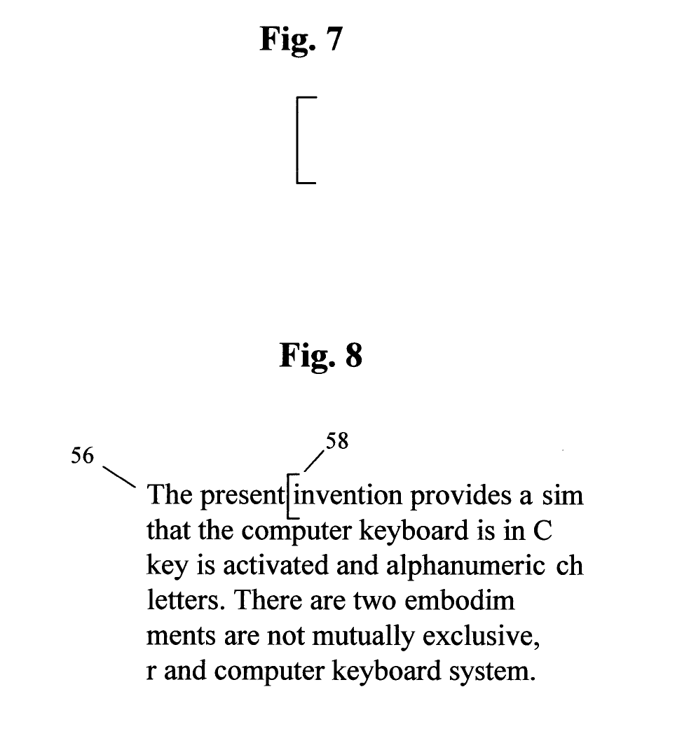

FIG. 7 illustrates one possible alternate shape for the text insertion cursor to serve the CAPS LOCK alert function. FIG. 8 illustrates a block of text 56 in which the new form of the text insertion cursor 58 can be seen between the words “present” and “invention”.

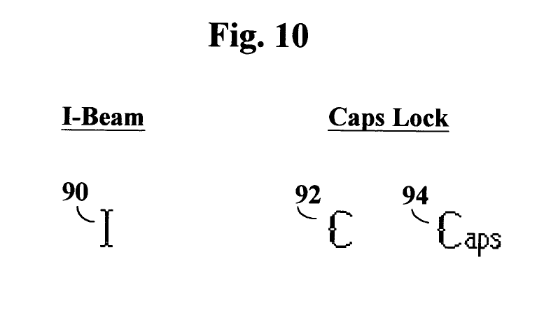

FIG. 10 illustrates a conventional I-beam mouse text pointer, labeled 90, and two versions of a CAPS LOCK mouse text pointer, labeled 92 and 94. In operation, when the mouse pointer is within (or “over”) a text object, the system or application displays the conventional I-beam mouse text pointer when not in CAPS LOCK mode, and presents a CAPS LOCK mouse text pointer such as 92 or 94 when in CAPS LOCK mode. The designs of 92 and 94 were created with the consideration that the user still needs a vertical guide to be able to properly set the text insertion cursor between characters. Therefore, version 92 is a stylized capital letter “C” having a straight and tall left edge which serves as the insertion point marker.

Cursors have a “hot spot” which identifies to the appropriate software the exact location within the cursor image that the mouse pointer points to—the hot spot of an arrow pointer, for example, is at the tip of the arrow. In the case of design 92, the hot spot is visible as a white dot in the middle of the left edge of the “C”. That white dot has a black pixel to the left and right to help identify the hot spot and so that the left edge does not appear “broken”. That being said, there is no obligation for the cursor artist to identify the hot spot to the user, although in some designs the hot spot is implicit (arrows, crosshairs, and so on). It is mentioned here simply because it was a design feature and might interest the reader.

Version 94 is the same letter “C” as version 92, with the addition of small, lower case letters “aps”, thus spelling out the word “Caps”. Of course, creating a cursor design is an artistic endeavor, and many other designs might be suitable for the purpose. The particular design is not material as long as it is different from the normal I-beam mouse text pointer, and the system or application switches between them based on the status of the CAPS LOCK key, displaying the standard text cursor (e.g., the I-beam) when not in CAPS LOCK mode, and displaying the CAPS LOCK version when in CAPS LOCK mode.

The CAPS LOCK text insertion cursor and the CAPS LOCK mouse text pointer can be implemented in a system independently or together.

Depending upon the particulars of the computer environment, the presentation of the text insertion cursor is caused by operating system software or by application software, or by both working together. Furthermore, in some computer environments a supplemental software element (an “add-in” module) can be written which will link into the standard system software environment to modify the normal system operation. Software of this type includes DLL's, device drivers, and ActiveX Controls, among others.

The CAPS LOCK visual indications of this invention can therefore be implemented in the operating system, in application software, or in an add-in module. In operation of the present invention, one or more software elements determine the status of the CAPS LOCK key or CAPS LOCK mode, and then present the appropriate text insertion cursor or mouse text pointer, or both; that is to say, if the CAPS LOCK key is on, or the system is in CAPS LOCK mode, the software elements present the CAPS LOCK alert text insertion cursor, otherwise they present the standard text insertion cursor; Similarly, if the CAPS LOCK key is on, or the system is in CAPS LOCK mode, the software elements present the CAPS LOCK mouse text pointer, otherwise they present the standard mouse text pointer.

In one method of operation an add-in module could, for example, exchange the standard text insertion cursor image or mouse text pointer image with the associated CAPS LOCK image when the CAPS LOCK key is on. The operating system and application software would cause the presentation of the text insertion cursor or mouse text pointer, while the add-in switches the image to coincide with the state of the CAPS LOCK key.

The general nature of the operation of a keyboard within a computer system is as follows: messages are generated by the keyboard electronics in response to a key press, the keyboard electronics delivers the messages to the computer operating system via a keyboard driver software component, and the computer operating system delivers the messages to the software application which presents the typed characters on the computer's screen. The operating system also makes available the status of individual keys for queries by applications and other software elements.

There are several contemporary computer hardware designs and operating systems. For example, there are currently a variety of Microsoft Windows operating systems in use, the BeOS (the Be Operating System), the Apple MacIntosh operating system, a wide variety of UNIX operating systems and derivatives including SUNOS (Sun Microsystems), HPUX (Hewlett Packard), and LINUX. Each hardware and software system presents a unique method of implementing keyboard functions into the overall system by the use of keyboard driver software, system messages, etc. In addition, the keyboard associated functions of this invention could be implemented by hardware and software not yet in existence. Therefore, the precise nature of the associated keyboard driver software and messages to be sent to the operating system or to a software application to indicate turning the CAPS LOCK mode on or off, or to indicate the typing of a symbol or alphabetic key while in CAPS LOCK mode are beyond the scope of this patent application. It is ample to point out that the methods and means to implement such functionality are well known in the art, and individuals skilled in the art would be capable of implementing a system which could function according to this invention.

Conveniently, both the Windows and Apple computer environments allow the software developer to create a custom cursor for use in their applications, and also allow the application to read the status of the keyboard keys, including the CAPS LOCK key. Because of these capabilities, a unique CAPS LOCK mouse text pointer can be easily implemented by software application developers, and such an application has been realized by the inventor for demonstration purposes. The inventor's demo application, a Notepad-type text editor, was built with Microsoft Visual Basic 6.0 using one of the provided application wizards. It required less than 20 additional lines of code to implement the CAPS LOCK mouse text pointer functionality. The fact that such an application is so easy to create and solves such an annoying problem is testimony to the unique aspect of this invention and the fact that it is unanticipated by prior art. Had someone thought of this at some time in the past, we wouldn't be dealing with this problem today because it would have been implemented immediately and universally.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. A computer software element, operating in an environment of a computer system having a keyboard with a CAPS LOCK key, said computer system operating in CAPS LOCK mode when said CAPS LOCK is activated, wherein said CAPS LOCK mode causes typed alphabetic characters to be presented on-screen in capital letters, comprising:
(a) means to present a mouse pointer on a display screen of said computer, said mouse pointer indicating the position where mouse events will take place;
(b) means to present a mouse pointer of one design when the mouse position is over a region for user text input and said computer system is not in said CAPS LOCK mode; and
(c) means to present a mouse pointer of a second design when the position is over a region for user text input and said computer system is in said CAPS LOCK mode.

2. A computer software element, as recited in claim 1, wherein said software element is an operating system.

3. A computer software element, as recited in claim 1, wherein said software element is an application program.

4. A computer software element, as recited in claim 1, wherein said software element is an add-in module.

5. A computer software element, operating in an environment of a computer system having a keyboard with a CAPS LOCK key, said computer system operating in CAPS LOCK mode when said CAPS LOCK key is activated, wherein said CAPS LOCK mode causes typed alphabetic characters to be presented on-screen in capital letters, comprising:
(a) means to present a text insertion cursor on a display screen of said computer, said text insertion cursor indicating the position where the next typed character will be presented;
(b) means to present a text insertion cursor of one design when said computer system in not in said CAPS LOCK mode; and
(c) means to present a text insertion cursor of a second design when said computer system is in said CAPS LOCK mode.

6. A computer software element, as recited in claim 5, wherein said software element is an operating system.

7. A computer software element, as recited in claim 5, wherein said software element is an application program.

8. A computer software element, as recited in claim 5, wherein said software element is an add-in module.
